(19) United States
(12) Patent Application Publication
(10) Pub. No.: US 2016/0119009 A1
(43) Pub. Date: Apr. 28, 2016

(54) ADJUSTABLE FARADAY HOLDER FOR ELECTRONIC DEVICES

(71) Applicants: Pauline Peterson, Vancouver (CA); Tom Peterson, Vancouver (CA)

(72) Inventors: Pauline Peterson, Vancouver (CA); Tom Peterson, Vancouver (CA)

(21) Appl. No.: 14/525,162

(22) Filed: Oct. 27, 2014

(51) Int. Cl. H04B 1/3827

(52) U.S. Cl. CPC H04B 1/3838; H04B 1/385

(57) ABSTRACT

The present invention includes a system for carrying an electronic device with a Faraday material configured to protect a user from undesirable wave radiation while allowing said electronic device to transmit and receive signals.

### BACKGROUND OF THE INVENTION

There is a growing body of evidence suggesting cell phone users should limit their exposure to cellphone signals (hereinafter referred to as “waves”), and including but not limited to electro magnetic fields (EMF) as well as the Electromagnetic radiation that is common to cell phones.

Electromagnetic radiation is made up of waves of electric and magnetic energy moving at the speed of light, according to the Federal Communications Commission (FCC). All electromagnetic energy falls somewhere on the electromagnetic spectrum, which ranges from extremely low frequency (ELF) radiation to X-rays and gamma rays.

All cell phones emit some amount of electromagnetic radiation. Cellphone “waves” fall into the spectrum of radio waves and microwaves. Given the close proximity of the phone to the body, it is contemplated that the radiation may cause some sort of harm to the 6 billion cell-phone users in the world. What is being debated in the scientific and political arenas is just how much radiation is considered unsafe, and if there are any potential long-term effects of cell-phone radiation exposure. Radio Frequency (“RF”) radiation has the ability to heat human tissue, much like the way microwave ovens heat food. Damage to tissue can be caused by exposure to RF radiation because the body is not equipped to dissipate excessive amounts of heat.

### SUMMARY OF THE INVENTION

The present invention is to integrate a Faraday cage-style lining and/or pocket into anything that comes into proximity with the body, to protect the user from unwanted cellphone radio frequency (RF) and electromagnetic field (EMF) energy.

The invention uses the proven scientific principle known as the “Faraday Cage Principle” first discovered in 1836 by Michael Faraday and used to contain Electro Magnetic Fields. In one embodiment, the invention is practiced by sewing a Faraday cage-style pocket or pouch made of interlocking metal threads or carbon fiber (or possibly other materials) into clothing, bags, purses, briefcases or anything that comes into close proximity with the body, to act as a container and pocket-shield for cellphones, to protect the user from unwanted cellphone RF and EMF energy (and all other types of energy, hereinafter “cellphone waves”).

The shield is constructed and arranged to allow the user to choose to partially or completely block the cellphone waves. Partially blocking the cellphone waves can allow the user to receive messages on their cellphone, but blocks the waves from harming the body of the user.

### BRIEF DESCRIPTION OF THE SEVERAL VIEWS OF THE DRAWINGS

FIG. 1A shows one embodiment of the present invention with the pocket affixed to a jacket.

FIG. 1B shows one embodiment of the present invention with the pocket affixed to a shirt or blouse

FIG. 1C shows one embodiment of the present invention with the pocket affixed to a sports bra or woman's athletic top.

FIG. 1D shows one embodiment of the present invention with the pocket affixed to shorts.

FIG. 2 is a plan view of one embodiment of the pocket according to the present invention.

FIG. 3 is a side cross-sectional view of the pocket according to one embodiment of the present invention.

FIG. 4 is a side cross-sectional view of the pocket according to one embodiment of the present invention with a device outside the Faraday material.

FIG. 5 is a plan view of an embodiment of the present invention utilizing a wristwatch with a device having electronic communication capabilities.

FIG. 6 is perspective view of a wristband utilizing the present invention.

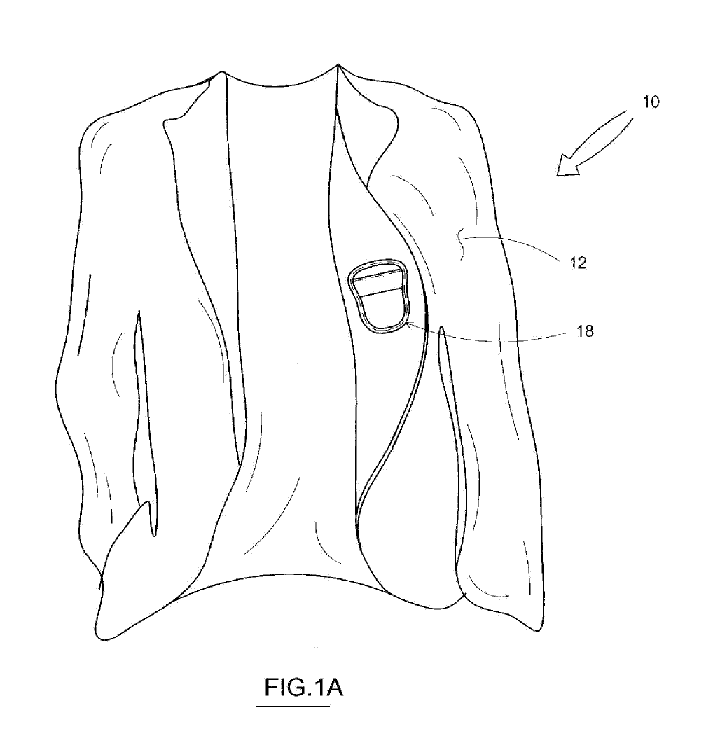

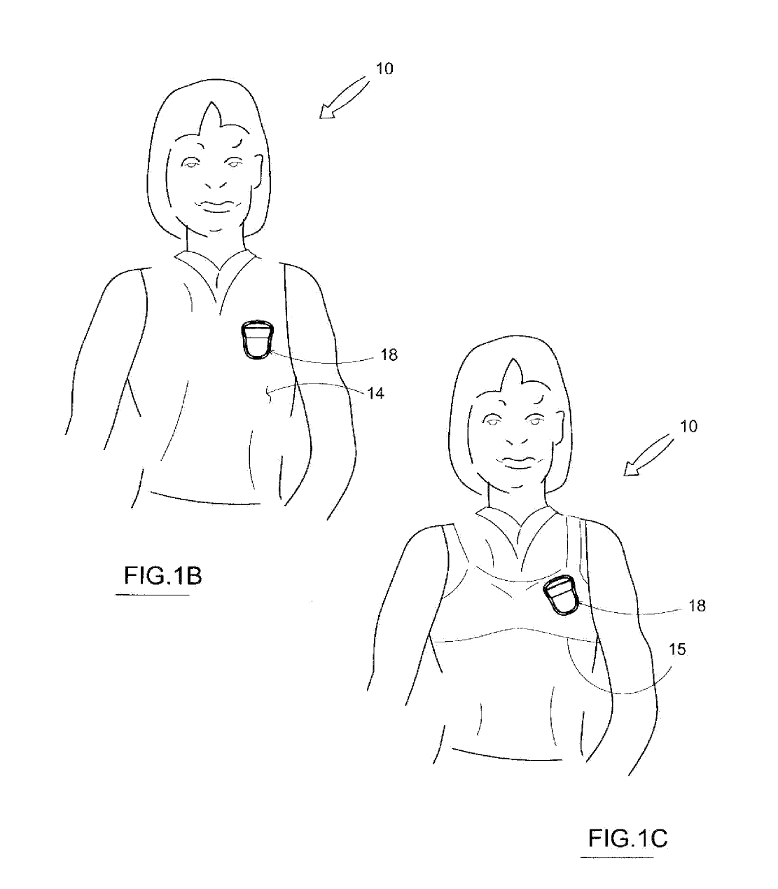

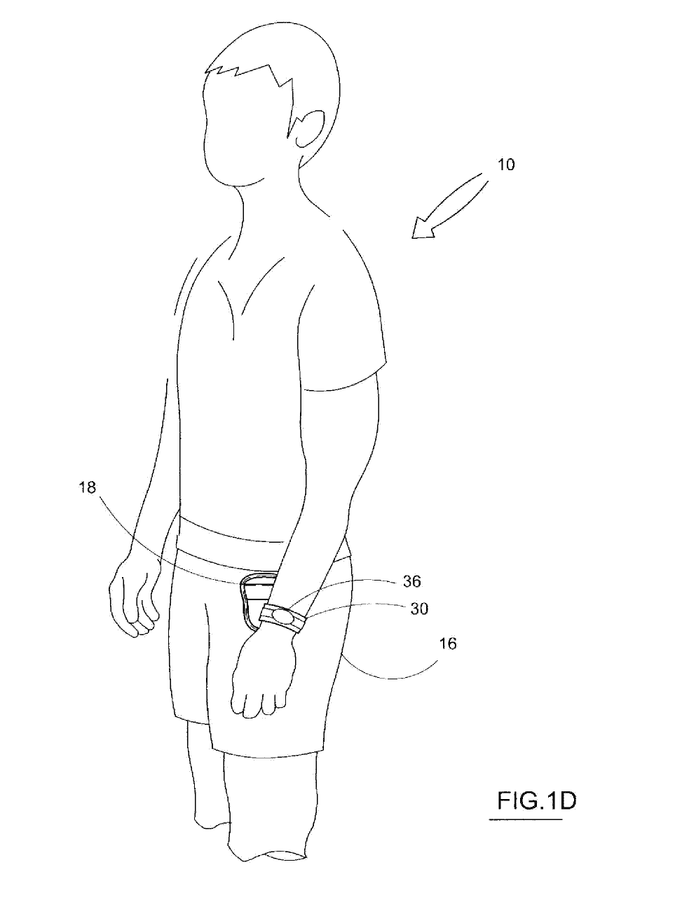

### DETAILED DESCRIPTION OF THE PREFERRED EMBODIMENT

The present invention relates to a Faraday holder for electronic devices. Although demonstrative use refers to a cell phone, the present invention is contemplated as being suitable for use with any electronic device in which radiofrequency and or electromagnetic field radiation is emitted and/or received.

Additionally, although the figures provide for several embodiments, namely, a jacket 12, a shirt and/or blouse 14, a sports bra and/or sports top 15, and shorts 16, these are merely demonstrative and are not intended to limit the system of the present invention.

Faraday enclosure devices are typically used to completely block the reception and transmission of wireless signals. However, when a person is using a cell phone and desires the phone to protect from harmful RF and/or EMF yet still have the ability to receive a wireless signal, a significant problem is presented. The present invention addresses this problem by providing a Faraday system that protects a user and selectively envelops an electronic device such that wireless communication is accessible to a device enclosed in the system.

In one embodiment, the system 10 includes a Faraday configured pocket 18 that includes Faraday effect material 20. There are many known materials that will impart a Faraday effect on radiofrequency and electro-magnetic field radiation and the present invention is contemplated to use any suitable material that will interfere with RF or EMF.

Electronic device 26 is positioned in pocket 18 whereby pocket 18 is formed of pocket material 22. Pocket 18 is formed with an optional pocket flap 24. In one embodiment, pocket flap 24 is formed and includes incorporated therewith a Faraday material. In one embodiment, flap 24 is merely a closure and does not include any Faraday material.

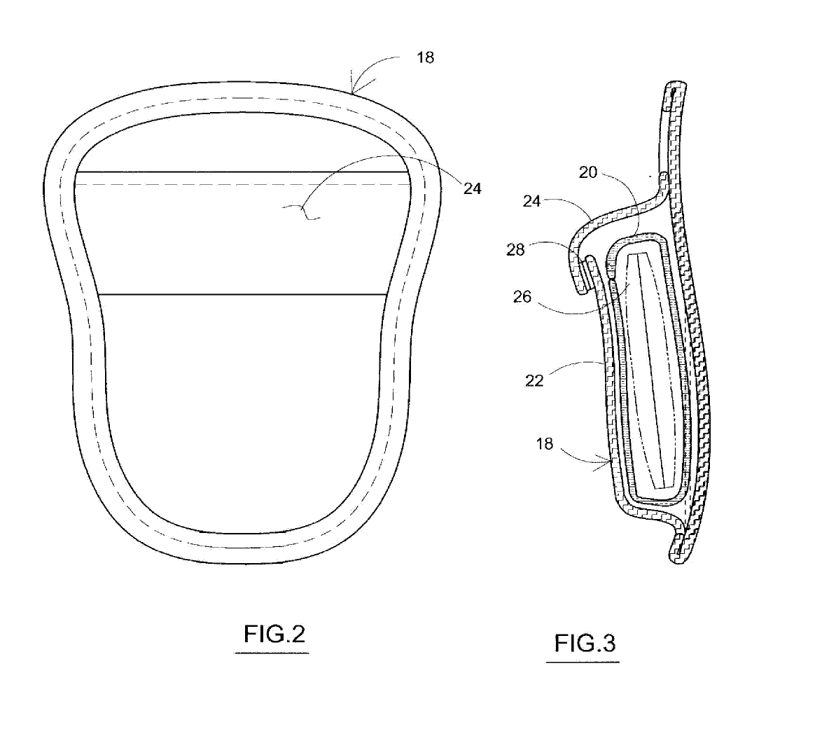

In one embodiment, pocket 18 is configured as demonstrated in FIG. 4 whereby electronic device 26 is inserted with in the cavity of pocket 18 and is not enveloped by the material 20. In this configuration, Faraday material 20 will block RF and or EMF in one direction and still allow for electronic device 26 to send and receive wireless communications.

In one embodiment, the pocket of the present invention is provided without any flap. The Faraday material is configured in a manner to protect the user from RF and/or EMF but the lack of any flap provides for a configuration whereby electronic transmissions are sent and received by a device carried in pocket 18 of the present invention.

In one embodiment, Faraday material 20 will include complete Faraday material in the direction facing the user and will be constructed of sections of Faraday material and non-Faraday material in the direction away from the user. In this embodiment, the communication with device 26 is maintained.

In an embodiment where flap 24 is constructed completely of non-Faraday material, communication with device 26 will be effectuated through flap 24.

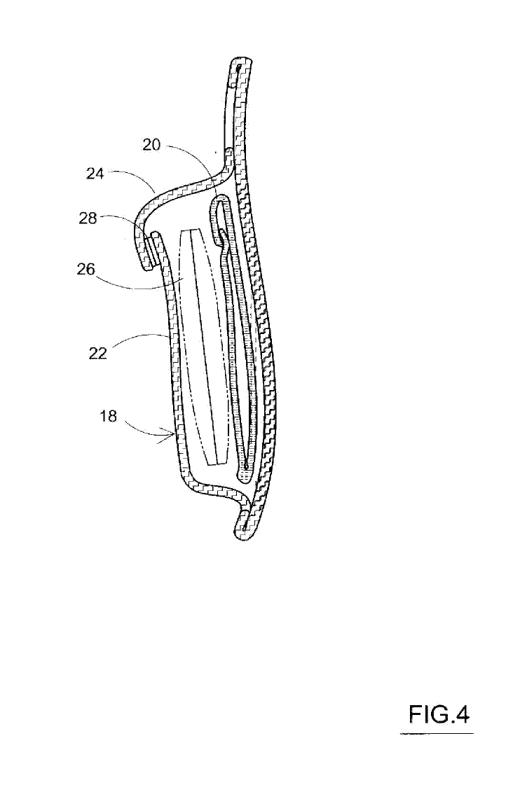

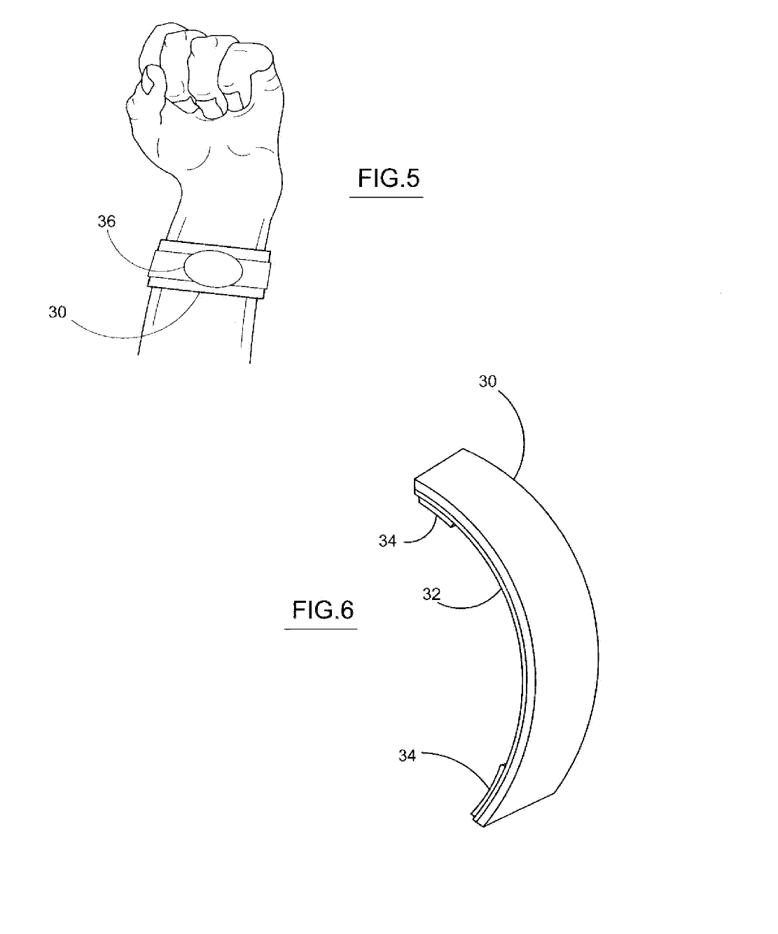

Currently, wristwatches (e.g. smart watches) are becoming available that include electronic communication capabilities. It is further contemplated that the present invention be incorporated as a protective barrier between the base of the watch and a user's wrist as demonstrated in FIGS. 5 and 6. In this embodiment, a Faraday-type material is affixed on the underside of the watch/wrist device. Wristband 30 includes an appropriate fastener 34 to secure about the perimeter of a user's wrist. In one embodiment, fastener 34 is a hook and loop fastener also known by the name Velcro® or any other appropriate system for securing a wristband. Faraday material 32 is positioned on wristband 30 in a configuration such that, in use, Faraday material 32 is between wearable electronic device 36, such as a wristwatch, smart watch, or other device, and the skin of a user. In one embodiment, Faraday material 32 is positioned on a portion of wristband 30 in a configuration congruous with the shape of the underside of the electronic device or watch 36 to cover the radio waves the watch device will use to communicate with the users cellphone/electronic device in the pocket.

In one embodiment, the material is affixed using a releasable adhesive.

While the invention has been described in its preferred form or embodiment with some degree of particularity, it is understood that this description has been given only by way of example and that numerous changes in the details of construction, fabrication, and use, including the combination and arrangement of parts, may be made without departing from the spirit and scope of the invention.

What is claimed is:

1. A system for holding an electronic device said system comprising:
a pocket formed of clothing material, said pocket affixed to an article of clothing and including an interior cavity;
at least one Faraday imparting material associated with said pocket; and
optionally, a flap or closure for said pocket.

2. The system of claim 1 whereby said Faraday imparting material is incorporated with the material forming said pocket.

3. The system of claim 1 whereby said faraday imparting material is positioned within the inner cavity of the pocket.

4. The system of claim 1 the pocket is configured with Faraday imparting material proximate to a user's skin.

5. The system of claim 1 the flap includes Faraday imparting material.

6. The system of claim 1 whereby the flap is free of any Faraday imparting material.

7. The system of claim 1 whereby the flap is Faraday imparting material connected thereto.

8. The system of claim 1 the article of clothing is at least one of a jacket, a shirt, a blouse, shorts, a sports bra, woman's athletic wear top or combinations thereof.

9. A system for holding a wearble electronic device said system comprising:
a wristband formed of material, said wristband having an outer surface and an inner surface whereby at least one of said outer surface and an inner surface is configured for holding an electronic device;
at least one Faraday imparting material associated with said wristband, whereby said Faraday material is positioned on an said inner surface positioning said Faraday material between said electronic device and a user's wrist.

10. A method of holding an electronic device, said method comprising the steps of:
providing a system of claim 1;
placing an electronic device in the pocket;
whereby said placing inhibits radiofrequency, electromagnetic field, or combinations thereof in direction of a person wearing the clothing including the system of claim 1.
